(19) United States
(12) Patent Application Publication
(10) Pub. No.: US 2023/0129348 A1
(43) Pub. Date: Apr. 27, 2023

(54) HEATING ELEMENT FOR EXHAUST LINE

(71) Applicant: FAURECIA SYSTEMES D'ECHAPPEMENT, Nanterre (FR)

(72) Inventors: Guillaume AUFRANC, COURCELLES-LES-MONTBELIARD (FR); Vincent LEBOURGEOIS, VOUJEAUCOURT (FR)

(21) Appl. No.: 17/971,773

(22) Filed: Oct. 24, 2022

(30) Foreign Application Priority Data
Oct. 25, 2021 (FR) 21 11320

(51) Int. Cl. F01N 3/20; F01N 3/10

(52) U.S. Cl. CPC F01N 3/2013; F01N 3/10; F01N 3/2006

(57) ABSTRACT

A heating element for an exhaust line includes a substantially tubular housing, which merges with an exhaust pipe of the exhaust line, and a heating disk that is arranged across a passage cross-section of the tubular housing. The heating element also includes at least one pad and at least one restoring member, where the at least one pad is fastened to a distal end of the at least one restoring member. The at least one restoring member is able to hold the at least one pad in abutment against the heating disk.

### CROSS-REFERENCE TO RELATED APPLICATIONS

This application is a U.S. non-provisional application claiming the benefit of French Application No. 21 11320, filed on Oct. 25, 2021, which is incorporated herein by reference in its entirety.

### TECHNICAL FIELD

The present disclosure relates to a heating element for an exhaust line.

### BACKGROUND

Such a heating element or EHC (electrically heated catalyst) is, in a known manner, used for preheating or heating a catalyst in order to enable the same to reach the minimum temperature of efficiency thereof, so that the catalyst can effectively depollute the exhaust gas. Such heating takes place by radiation and/or by convection. The heating element is typically located immediately upstream of the catalyst.

According to a known embodiment, a heating element comprises a housing which is substantially tubular so as to provide a passage cross-section, arranged in or replacing an exhaust pipe, wherein an exhaust gas coming from a heat engine flows. A heating disk is arranged inside the housing, across the passage cross-section.

The heating disk is perforated and/or porous, in order to let the exhaust gas through the cross-section thereof. Moreover, the heating disk is metallic and resistant. The heating disk is connected to at least two electrodes for letting an electric current flow within the heating disk, so as to heat the heating disk by the Joule effect. The heat is transmitted to the catalyst which is located downstream of the heating disk, by radiation and by convection, the heat being transported by the gases, air or exhaust gases, flowing through the heating disk.

Current design trends for a heating disk is to reduce the thickness thereof. Such a reduction is advantageously accompanied by a reduction in the mass of the disk, reducing the thermal inertia thereof and promoting a rapid rise in temperature, in addition to being beneficial to the mass budget of the vehicle. Moreover, a reduction in the thickness thereof is most often accompanied by a favorable increase in the electrical resistance thereof.

A reduction in the thickness of the heating disk is however, accompanied, in a detrimental way, by a reduction in the natural frequency thereof, which is detrimental to the longevity of the heating disk.

### SUMMARY

The subject disclosure provides an embodiment to increase the natural frequency of a heating disk, preferentially without increasing its thickness and/or its mass.

The principle of the disclosure is to arrange pads, held in contact against the heating disk, for damping the vibration modes of greater amplitude.

For this purpose, the disclosure relates to a heating element for an exhaust line, comprising a substantially tubular housing merging with an exhaust pipe of the exhaust line, and a heating disk arranged across a passage cross-section of the tubular housing. The heating element also includes at least one pad and at least one restoring member, where the at least one pad is fastened at a distal end of the at least one restoring member. The at least one restoring member is able to hold said at least one pad in abutment against the heating disk.

Particular features or embodiments, which can be used alone or in combination, are:
a pad being electrically insulating,
a pad having a face in contact with the heating disk and being able to slide over the heating disk and preferentially flat,
a restoring member comprising an elbowed elastic metal strip, fastened by a proximal end thereof to an inner wall of the housing,
a restoring member being shaped in such a way as to place a pad associated with a vibration node of the heating disk,
the heating element further comprising, facing a first face of the heating disk, a first ring with pads and restoring members,
the heating element further comprising, facing a second face of the heating disk opposite the first face, a porous ceramic support, preferentially a ceramic support apt to depollute, yet preferentially a catalyst,
the heating element further comprising, facing a second face of the heating disk opposite the first face, a second ring with pads and restoring members,
every pad of the first ring facing a pad of the second ring and preferentially vice versa,
the number of pads in a ring being a multiple of 4, and is comprised between 4 and 32,
the pads of a ring, being arranged along a common diameter, and preferentially identical from one ring to another, if any, ring,
the stiffness of the restoring members of a ring being identical,
the stiffness of the restoring members of a downstream ring, relative to a direction of flow of the exhaust gas, being greater than the stiffness of the restoring members of an upstream ring.

In a second aspect of the disclosure, an exhaust line comprises at least one such heating element.

In a third aspect of the disclosure, a vehicle comprises such an exhaust line.

### BRIEF DESCRIPTION OF THE DRAWINGS

The disclosure will be better understood upon reading the following description, given only as an example and making reference to the enclosed drawings, wherein:

FIG. 1 shows an embodiment with a single ring with restoring members and pads, on one side of the heating disk,

FIG. 2 shows another embodiment with a ring with restoring members and pads, on each side of the heating disk,

FIG. 3 shows a diagram indicating the position of the vibration nodes.

### DETAILED DESCRIPTION

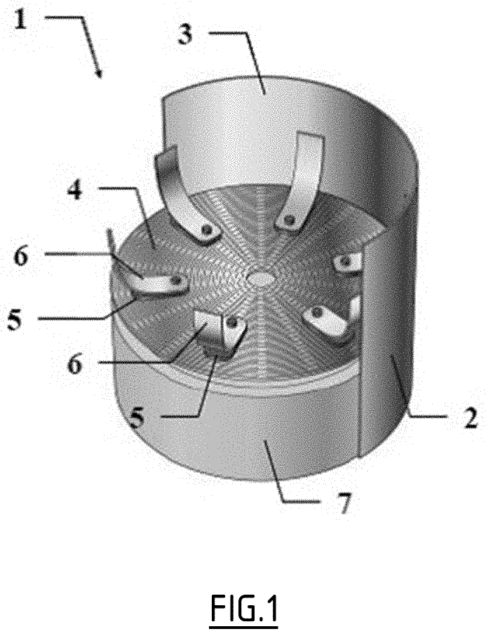

With reference to FIG. 1, the disclosure relates to a heating element 1 for an exhaust line. Such a heating element 1 comprises a substantially tubular housing 2. The tubular section can be arbitrary. In the embodiment illustrated, the passage cross-section is circular. The housing 2 merges and aligns with thereof, or even locally replaces, an exhaust pipe 3 of the exhaust line. The exhaust gas flows through the pipe 3 and crosses the housing 2 during the flow thereof from the engine to the exhaust nozzle. A heating disk 4 in the form of a wafer with an outer cross-section substantially identical to the passage cross-section of the housing 2 is arranged across the passage cross-section of the housing 2.

In a known manner, the heating disk 4 is made, at least in part, of metallic material so as to be electrically resistant. The heating disk 4 is connected, by at least two electrodes (not shown), to a source of current. Thus, the current flowing through the heating disk 4 heats the disk by the Joule effect. Said at least two electrodes are arranged, one at the center and the other at the periphery of the heating disk 4. Alternatively, the electrodes can all be located at the periphery.

The electrodes, whatever the arrangement thereof, are rigidly attached to the heating disk 4, and have a function of supporting the heating disk 4 and of fastening the same to the housing 2.

Alternatively or additionally, the heating disk 4 can be supported on the periphery thereof. Such support can be achieved by embedding the heating disk 4 into a peripheral support rigidly attached to the housing 2. Advantageously, the embedding is such that it authorizes a radial degree of freedom for the displacement/deformation of the heating disk 4 under the effect of thermal expansion.

Such a fastening, whatever the embodiment thereof, is limited to the periphery of the heating disk 4, supplemented, if appropriate, by a central point.

Thus, the major part of the surface of the heating disk 4 is free. Under the effect of vibrations and in particular of variable pressure waves due to the exhaust gas, the free surface of the heating disk 4 can vibrate. The above is all the more significant for commercial vehicles, for which the surface area of the passage cross-section is increased and for which the pressure waves are of greater amplitudes.

Current design trends for a heating disk 4 are to reduce the thickness thereof. Such reduction is advantageously accompanied by a reduction in the mass of the heating disk 4, reducing the thermal inertia thereof and promoting the rapid rise in temperature of the heating disk, in addition to being beneficial to the mass budget of the vehicle. Moreover, a reduction in the thickness thereof is most often accompanied by a favorable increase in the electrical resistance thereof.

However, a reduction in the thickness of the heating disk 4 is accompanied, in a detrimental way, by a reduction in the natural frequency thereof. Such a reduction increases the amplitudes of deformation, and is detrimental to the longevity of the heating disk 4.

Thus, the disclosure seeks to increase the natural frequency of the heating disk 4 without increasing the structure and/or the weight thereof.

According to one feature, the heating element 1 further comprises at least one pad 5. Such at least one pad 5 is designed to abut, in a maintained manner, against the surface of the heating disk 4. For this purpose, the heating element 1 comprises as many restoring members 6 as there are pads 5. Each restoring member 6 supports a pad 5. The pad 5 is fastened to a distal end of the restoring member 6. this fastening is performed by any fastening method.

The restoring member 6 is shaped so as to keep said at least one pad 5 abutting against the surface of the heating disk 4. In a possible embodiment, the restoring member 6 is integrated in the wall of the housing 2.

In order not to disturb the flow of the current providing the heating of the heating disk 4, according to another feature, a pad 5 is electrically insulating.

According to one possible embodiment, in order to achieve galvanic isolation, while resisting the very high temperatures which can occur in an exhaust line, a pad 5 is made of ceramic. Alternatively, according to another embodiment, a pad 5 can be made of any material, including an electrically conducting material, and covered with an electrically insulating varnish.

According to another feature, a pad 5 is designed so as to be able to slide, on the surface of the heating disk 4, at least in the zone where the pad is in contact. Such sliding is possible at least radially, such direction being a preferred direction of displacement/deformation of the heating disk 4, mainly under the effect of thermal expansion.

For this purpose, the face of a pad 5 which is in contact with the heating disk 4 has a contact face apt to slide on the heating disk 4. The contact face is preferentially plane. Thus, the pad 5 can take up a radial deformation of the heating disk 4, at least within the amplitude caused by the thermal expansion of the heating disk 4.

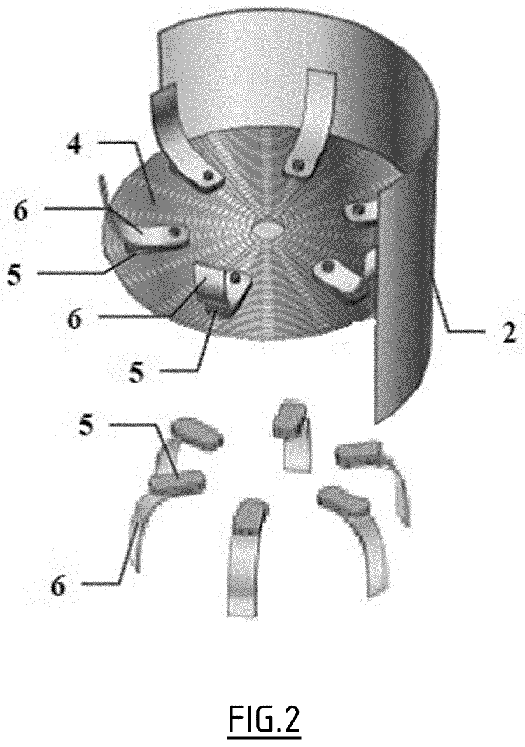

The shape of the restoring member 6 can be arbitrary. According to another feature, a restoring member 6 comprises an elastic metal strip 6. The metal strip 6 bears the pad 5 at the distal end thereof. The metal strip is fastened by the proximal end thereof to the inner wall of the housing 2. Such fastening can advantageously be performed by any method. As an illustration, these methods can include welding, riveting or any other equivalent way of fastening. The metal strip 6 is made of an elastic material, such as a metal material for springs, i.e. a material with a high elastic limit. It can be a steel for springs or further a nickel alloy such as Inconel. Said metal strip 6 is advantageously elbowed, as shown in FIGS. 1 and 2, substantially at 90°, in order to present the pad 5 thereof abutting against the heating disk 4 and allow the same to be fastened to the inner wall of the housing 2, substantially perpendicular to the surface of the heating disk 4. The elbow of the metal strip 6 is advantageously such that the abutment of the pad 5 on the heating disk 4 has a prestress, so as to ensure a maintained abutment of the pad 5 against the heating disk 4.

As has been seen previously, the main function of a pad 5 is to produce a vibration damper, making it possible to achieve a substantial increase in the natural frequency of the heating disk 4. Thus, according to a particularly advantageous feature, a pad 5 is placed in line with a point closest to a vibration node of the heating disk 4. For this purpose, a restoring member 6, which bears the associated pad 5, is shaped so as to place said associated pad 5 in line with a vibration node of the heating disk 4. Thus placed, a pad 5 reduces the most significant vibration of the heating disk 4.

The equivalent natural frequency of the heating disk 4 damped by the pad(s) 5 is thus clearly increased. Current thinned disks have a free natural frequency on the order of 60 to 80 Hz. Such a natural frequency is too low in terms of durability. The objective sought, achieved by the disclosure, is to increase such frequency until reaching a natural frequency with pads 5 on the order of 300 to 350 Hz.

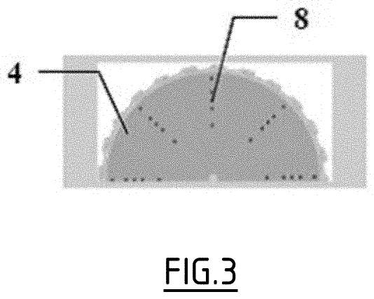

As illustrated in FIG. 3, representing a diagram showing a heating half-disk 4, herein with a circular shape, the vibration nodes 8, or points of greatest vibration amplitude, have an axisymmetric distribution. Such nodes 8 are superposed with strand/sector junctions. Moreover, the nodes 8 are aligned on radii, herein in number of 8.

Thus, according to another feature, the pads 5 advantageously have a radial elongation so as to radially abut on several vibration nodes 8. The above advantageously replaces a plurality of substantially individual pads 5.

According to a first embodiment, more particularly illustrated in FIG. 1, a heating element 1 comprises a first ring with pads 5 and associated restoring members 6. Such pads 5 are advantageously arranged facing only one face of the heating disk 4. In such embodiment, the heating disk 4 abuts, by the other face thereof, against a substantially flat support. Such support can be a porous ceramic support, preferentially a ceramic support apt to depollute. Still preferentially, as illustrated, the support is the upstream face of a catalyst 7.

According to another embodiment, more particularly illustrated in FIG. 2, a heating element 1 comprises a first ring as described above, and in addition a second ring of with pads 5 and associated restoring members 6. In FIG. 2, the second ring is shown at a distance from the heating disk 4 so as to improve visibility. However, in use, the second ring abuts under stress against the second face of the heating disk 4.

The pads 5 of the second ring are advantageously arranged facing the other opposite face of the heating disk 4. There is thus a ring on each side of the heating disk 4.

According to another feature, every pad 5 of the first ring is facing a pad 5 of the second ring. Preferentially, the reciprocal is true, every pad 5 of the second ring faces a pad 5 of the first ring.

It has been seen that, for an axisymmetric cross-section of passage, the distribution of the vibration nodes 8 is axisymmetric. Moreover, n angularly equally distributed radii of nodes 8 superposed with the sectors of the heating disk 4, are visible. Also, the number of pads 5 of a ring is advantageously a multiple of 2. Such number is comprised between 2, advantageous in that same minimizes the number of pads 5 and restoring members 6 and hence the cost and the associated head loss, and 32 which by multiplying the number of pads 5 and contact points, accordingly increases the rigidity of the heating disk 4.

Although not mandatory, according to another feature, the pads 5 of a ring are arranged along the same diameter. Such diameter can be different from one ring to another or can be identical from one ring to another, in the case where there are two rings.

According to another feature, in order for each pad 5 to exert a comparable abutment on the heating disk 4, the stiffness of the restoring member 6 of a ring is identical within a ring.

The stiffness of the restoring members 6 of one ring can also be identical to the stiffness of the restoring members 6 of the other ring, if same is present.

However, an asymmetry appears between the upstream ring which receives the exhaust gas and the pressure waves thereof from the back, and the downstream ring which receives the exhaust gas and the pressure waves thereof from the front. Upstream and downstream are defined herein with respect to the direction of flow of the exhaust gas. Thus, according to another feature, the stiffness of the restoring members 6 of the downstream ring, with respect to the direction of flow of the exhaust gas, is chosen to be greater than the stiffness of the restoring members 6 of the upstream ring. The above is done in order to rebalance the asymmetry, so as to keep the heating disk 4 axially centered, including under the effect of the pressure exerted by the flow of exhaust gases, flowing from upstream to downstream.

The disclosure further relates to an exhaust line comprising at least one heating element 1, as described above.

The disclosure further relates to a commercial or light vehicle comprising such an exhaust line.

The disclosure has been illustrated and described in detail in the drawings and the preceding description. The description should be considered as illustrative and given as example and not limiting the disclosure to said description alone. Many variants of embodiments are possible.

### List of Reference Symbols

1: heating element,
2: housing,
3: exhaust pipe,
4: heating disk,
5: pad,
6: restoring member,
7: catalyst,
8: vibration node

1. A heating element for an exhaust line, comprising:
a substantially tubular housing merging with an exhaust pipe of the exhaust line;
a heating disk supported by a wall of the housing, and arranged across a passage cross-section of the substantially tubular housing; and
at least one pad and at least one restoring member bearing one of the at least one pads by being fastened at a distal end of the at least one restoring member, a proximal end of the at least one restoring member being supported by the wall of the housing, and the at least one restoring member being able to hold the at least one pad abutting against the heating disk.

2. The heating element according to the claim 1, wherein the at least one pad is electrically insulating.

3. The heating element according to the claim 1, wherein the at least one pad has a face in contact with the heating disk and is able to slide over the heating disk.

4. The heating element according to the claim 1, wherein the at least one restoring member comprises an elbowed elastic metal strip fastened at the proximal end thereof to an inner wall of the substantially tubular housing.

5. The heating element according to the claim 1, wherein the at least one restoring member is shaped to place the one of the at least one pads at a point closest to a vibration node of the heating disk.

6. The heating element according to the claim 1, wherein the at least one pad comprises a plurality of pads and the at least one restoring member comprises a plurality of restoring members, and further comprising, facing a first face of the heating disk, a first ring with the plurality of pads and the plurality of restoring members.

7. The heating element according to claim 6, further comprising, facing a second face of the heating disk opposite the first face, a porous ceramic support.

8. The heating element according to claim 6, further comprising, facing a second face of the heating disk opposite the first face, a second ring with additional pads from the plurality of and additional restoring members from the plurality of restoring members.

9. The heating element according to claim 8, wherein every pad of the plurality of pads of the first ring faces another pad of the plurality of pads of the second ring.

10. The heating element according to claim 6, wherein a number of the plurality of pads of the first ring is a multiple of 2.

11. The heating element according to claim 6, wherein the plurality of pads of the first ring are arranged along a common diameter.

12. The heating element according to claim 6, wherein a stiffness of each of the restoring members of the first ring is identical.

13. The heating element according to claim 8, wherein one of the first ring and the second ring comprises an upstream ring, and wherein the other of the first ring and the second ring comprises a downstream ring, and wherein a stiffness of the restoring members of the downstream ring, with respect to a direction of flow of exhaust gas, is greater than a stiffness of the restoring members of the upstream ring.

14. An exhaust line that comprises at least one heating element according to the claim 1.

15. A heating element according to claim 1, wherein the restoring member is integrated in the wall of the housing.

16. The heating element according to the claim 3, wherein the face in contact with the heating disk is plane.

17. The heating element according to claim 5, wherein the heating disk supported by the wall of the housing comprises the vibration node, the restoring member being shaped in such a way as to place a pad associated with the vibration node of the heating disk.
